(19) United States
(12) Patent Application Publication
(10) Pub. No.: US 2003/0191669 A1
(43) Pub. Date: Oct. 9, 2003

(54) System for providing consumer access to healthcare related information

(76) Inventors: David Fitzgerald, West Grove, PA (US); Brian Lucas, Springfield, PA (US); David Hiebert Klassen SR., Paoli, PA (US)

Correspondence Address: ALEXANDER J. BURKE, SIEMENS CORPORATION, 170 WOOD AVE S, ISELIN, NJ, 08830, US

(21) Appl. No.: 10/336,990

(22) Filed: Jan. 6, 2003

Related U.S. Application Data
(60) Provisional application No. 60/371,027, filed on Apr. 9, 2002.
(60) Provisional application No. 60/374,568, filed on Apr. 22, 2002.

(51) Int. Cl. G06F 17/60; G06F 7/00; G06F 17/00

(52) U.S. Cl. 705/2; 707/100

(57) ABSTRACT

A system uses aggregated healthcare encounter service, billing, and claim data to enable an authorized patient to access healthcare encounter related information. A system supports patient access to healthcare encounter related information including information concerning an event involving interaction of a patient with a healthcare enterprise. The system includes an interface processor for receiving patient identification information and a request for encounter related information. The system also includes a database linking a patient identifier with, a record identifying at least one patient encounter and data identifying at least one healthcare provider organization associated with the at least one patient encounter and a record containing encounter information related to the at least one patient encounter. A data processor accesses the database to provide encounter related information for a patient and processes the encounter related information to be suitable for output communication for presentation to the patient in response to the patient identification information and the request.

This is a non-provisional application of provisional application serial No. 60/371,027 by D. Fitzgerald et al. filed Apr. 9, 2002 and of provisional application serial No. 60/374,568 by D. Fitzgerald et al. filed Apr. 22, 2002.

### FIELD OF THE INVENTION

This invention concerns a system and user interface for use in supporting patient access to healthcare encounter related information and enabling a patient to initiate scheduling of an encounter and to update patient related healthcare encounter information.

### BACKGROUND OF THE INVENTION

An important function performed by healthcare providers (such as hospitals, clinics or physicians) is the sending of claims to healthcare payer institutions to obtain reimbursement for provision of services to a patient. These claims may be in electronic or paper format. Paper claims typically go through a data entry process that converts them to an electronic format. The entered electronic claims are usually sorted, indexed and archived. Each claim is processed in a payer institution adjudication system. The payer adjudication system interprets the claim data and determines whether or not the claim is to be paid in full, partially paid or denied. This adjudication process may be fully automated, partially automated, or manual. The results of claim adjudication may include the issuance of a check and an explanation of benefits (EOB) to the insured and healthcare provider, or a request to send additional information.

The Healthcare claim adjudication and associated billing and payment process is encumbered with problems. Patients often do not understand the proffered reason for claim denial or rejection and are frustrated by the limited methods available for tracking and monitoring progress of a claim submitted to a healthcare payer organization. Known systems approach the problem from a healthcare payer or provider perspective. A provider tracks the status of each individual claim and follows-up with the payer. A payer would monitor the activities of the provider to check claim calculations are correct under current payer rules. Patients are provided limited methods of determining claim status or of determining status of other administrative and clinical healthcare procedures such as eligibility verification, pre-certification requests or referrals to specialists, for example. Compounding the problem associated with this task, is the fact that a single medical incident can generate multiple claims for each clinician involved (physician, surgeon, anesthesiologist, physical therapist, pathologist, radiologist) and a patient may be faced with the burden of contacting multiple different entities of a multi-faceted health system to determine the status of a matter. Further, the most common method of making such a contact currently in use is telephone access to a typically labyrinthine customer services department. A patient currently may have no viable way of knowing whether a claim has been submitted, rejected or paid. Also a submitted claim may have been denied for missing information that the patient could have readily provided if aware of the deficiency. Also, an access system should be secure and prevent unauthorized access to confidential medical data. A system according to invention principles addresses these requirements and associated problems.

### SUMMARY OF INVENTION

A system uses aggregated healthcare encounter service, billing, and claim data to enable an authorized patient to access healthcare encounter related information concerning pre-certifications, referrals, eligibility verification, healthcare services availability, co-payments, deductibles, claims and payment status in providing a consolidated view of activity across multiple claims via the Internet, for example. A system supports patient access to healthcare encounter related information including information concerning an event involving interaction of a patient with a healthcare enterprise. The system includes an interface processor for receiving patient identification information and a request for encounter related information. The system also includes a database linking a patient identifier with, a record identifying at least one patient encounter and data identifying at least one healthcare provider organization associated with the at least one patient encounter and a record containing encounter information related to the at least one patient encounter. A data processor accesses the database to provide encounter related information for a patient and processes the encounter related information to be suitable for output communication for presentation to the patient in response to the patient identification information and the request.

### BRIEF DESCRIPTION OF THE DRAWING

FIG. 1 shows an overall encounter data processing system enabling an authorized patient to access healthcare encounter related information, according to invention principles.

FIG. 2 shows a system configuration enabling an authorized patient to access healthcare encounter related information, according to invention principles.

FIG. 3 shows a flowchart of a process employed in providing an authorized patient with access to healthcare encounter related information by the system of FIGS. 1 and 2, according to invention principles.

FIG. 4 shows a user interface display image illustrating, a patient claim billing record for multiple patient encounters with a healthcare provider concerning treatment of an injury, according to invention principles.

FIG. 5 shows exemplary claim data processing rules associated with clinical events occurring to a patient, according to invention principles.

FIG. 6 shows a flowchart of a process supporting a patient in scheduling a visit to a healthcare provider to receive a proposed procedure and involving checking whether the proposed procedure meets medical necessity requirements of a payer, according to invention principles.

FIG. 7 shows a flowchart of a further process supporting a patient in scheduling a visit to a healthcare provider to receive a proposed procedure and involving determining whether a proposed procedure is covered by a patient healthcare plan, according to invention principles.

FIG. 8 shows patient accessed collated encounter related information, according to invention principles.

FIGS. 9-15 show healthcare encounter related information records accessible by an authorized patient, according to invention principles.

### DETAILED DESCRIPTION OF INVENTION

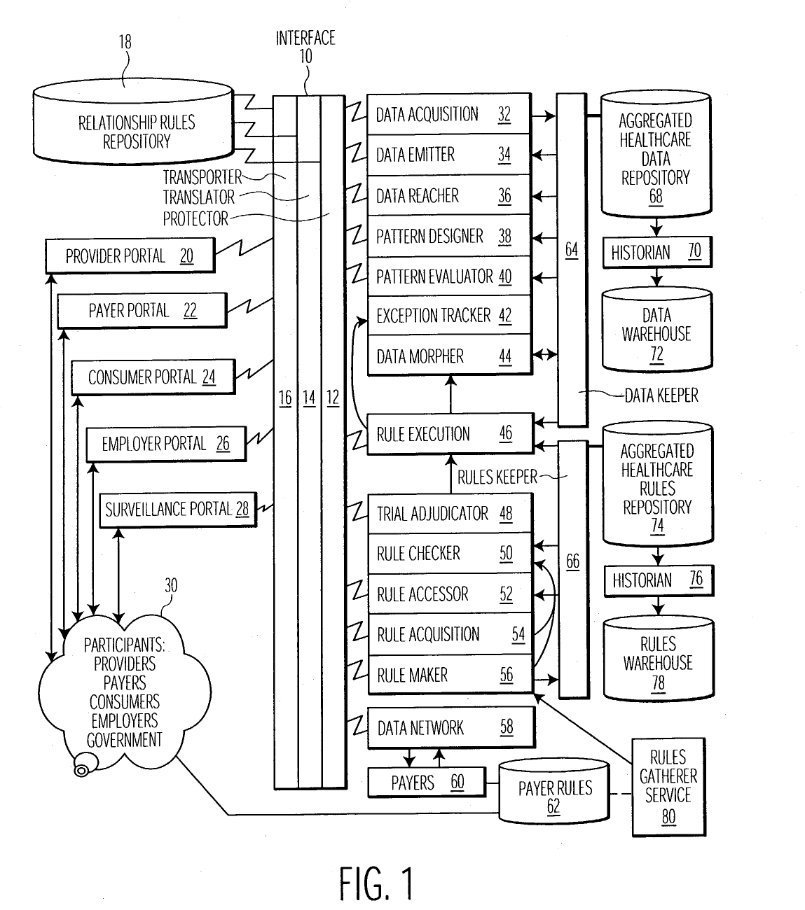

The inventors have advantageously recognized that it is desirable to provide a system capable of providing efficient patient access to information concerning pre-certifications, referrals, eligibility verification, healthcare services availability, co-payments, deductibles, claims and payment status. It is further desirable that such patient information access is available during convenient hours (ideally 24 hours a day every day) and from convenient locations. FIG. 1 shows an overall encounter data processing system enabling an authorized patient (or a consumer) to access healthcare encounter related information. An encounter as used herein comprises a patient encounter with a healthcare enterprise involving patient and healthcare enterprise interaction that has a financial or transaction consequence and may include for example a patient visit, phone call, inpatient stay or outpatient treatment, an interview, an examination, a procedure, a treatment related occurrence, an admission to a healthcare enterprise, a test or an order for medication etc. In the FIG. 1 system, aggregated healthcare encounter service, billing, and claim data in repository 68 is used to enable an authorized patient to access healthcare encounter related information concerning pre-certifications, referrals, eligibility verification, healthcare services availability, co-payments, deductibles, claims and payment status. The system securely provides a patient via the Internet, for example, with the information in a variety of formats including as a consolidated view of activity across multiple patient claims. A patient is thereby able to track data concerning an episode of care, plus has the opportunity to correct data that might result in erroneous billing. A patient is also able to access payer organization health plan insurance reimbursement and treatment eligibility rules including cumulative limits, family and personal deductible amounts, limits on the number of visits permitted in a predetermined period and reimbursement limits per particular medical condition (e.g., for a year or over a patient lifetime). A patient is similarly able to determine approved pharmacies or other service providers, obtain authorization for a second opinion, determine referral requirements and find approved medications as well as non-covered services. Further, the system of FIG. 1 enables an authorized user to access another individual's records (typically a family member or user that is fiscally responsible for that individual) and enables a patient to assign authority to another individual or entity to access his confidential information. Access is strictly controlled based on policy data supplied by the payer to prevent unauthorized access to confidential patient information. The FIG. 1 system also supports electronic dialog between a healthcare provider and a payer organization that allows a patient or fiscally responsible party to interact directly with payer organizations and healthcare providers to communicate concerns about information viewed or to request that incorrect information be corrected.

The FIG. 1 aggregated healthcare encounter service, billing, and claim data repository 68 comprises a relational database linking a record of an encounter resulting in a claim with patient health plan reimbursement and eligibility rules as well as remittance records for a patient medical episode or illness. The database uses known techniques to logically link multiple encounters related to care including pre-admission testing, inpatient stay, outpatient follow-up, bills and payments across multiple providers and locations. Thereby repository 68 enables a user, such as a patient via consumer portal 24, to access information concerning a particular claim, encounter, patient coverage rule or remittance record. Similarly a user is able to view a history of claim updates and coverage rule changes that may impact claim submission and reimbursement. Repository 68 also enables a user to view elapsed time between events (discussed later) and to view activity of multiple individuals or of one or more individuals within a user defined time period.

A rule as used herein comprises a procedure for determining that healthcare claim elements comply with predetermined requirements including, health plan reimbursement conditions, health plan format requirements, a reimbursement formula, reimbursement constraints and a reimbursement computation procedure. A rule also may comprise a prescribed guide, a precept, or a model for how to present, conduct or regulate an action by using a form and data or the relations between form and data. Further, an exception as used herein encompasses the identification of an issue and mechanism to process that issue and claim elements as used herein may comprise a portion of a claim, a complete claim, individual records of a claim and record data associated with an individual patient encounter with a healthcare service provider. Further, a claim is an instrument used by insurance companies to recognize services and related changes but it does not create an absolute expectation of payment. In contrast, a bill (typically directed to a guarantor or other fiscally responsible party) is an expectation of payment.

The FIG. 1 system automates the pre-registration, eligibility, registration authorization, claim generation, trial adjudication, claim submission, payment remittance, and post-remittance processes of a health care claim data processing cycle to provide seamless, accurate and prompt claim processing. The system automates coordination of employer and payer activities and ensures that pre-visit enrollee data is accurate. Thereby, if a patient uses a consumer portal (24) to schedule a visit or if a healthcare facility collects insurance information from a patient, medical necessity, referral and eligibility verification processing is automatically initiated. A claim is evaluated for accuracy and edited by a rule execution function 46 and adjudication unit 48, using the applicable rules in rules repository 74, both before the claim is completed (i.e. as individual claim elements for individual healthcare encounters post to the claim, for example) and again before the completed claim is submitted for payment. A variety of portals 20-28 in the FIG. 1 system are controlled and administered by interface 10 to provide claim data access to patients, payers, providers, employers and government agencies. The system facilitates healthcare provider compliance with governmental and payer rules through use of automated, rules-based editing and review systems.

The FIG. 1 system comprises functions implemented in software applications and executable procedures for processing claim data. These functions may also be implemented in hardware or a combination of both hardware and software resident in one or more computer systems and servers and involving one or more communication networks for internal and external communication. The system processes claim data related to provision of healthcare to a patient by collating data related to a claim for a particular patient for submission to a payer. The collated claim data is submitted for pre-processing using rules to validate the collated claim data is in condition for processing to initiate generation of payment. Upon successful validation the validated claim data is submitted to a payer. The claim data is collated by data acquisition unit 32 via interface 10 for storage in data repository 68. Repository 68 contains aggregated healthcare encounter service, billing, and claim data including financial and clinical data related to healthcare encounters that are currently ongoing. Data acquisition unit 32 is able to receive both solicited and unsolicited data from multiple different sources and to request data from these sources via interface 10. The different sources include external users (participants) subscribing to and using the FIG. 1 system and may include for example, healthcare providers, healthcare payer institutions (e.g. insurance companies, Health Maintenance Organizations—HMOs etc.), consumers, employers, and government agencies.

Data keeper unit 64 acts as a gateway and data management system governing data storage and retrieval for healthcare data repository 68 and processing requests to use repository 68 to store, modify, and retrieve data. Historian unit 70 tracks data changes in repository 68 by recording time, date and nature of changes made as well as the source and identity of the author of the changes to maintain a data update audit trial. Historian unit 70 is also used in archiving and maintaining older data value versions and is specifically used in archiving data records associated with patient encounters following completion of financial transactions (i.e. encounters for which no related financial transactions are outstanding) and processing for these encounters. Records of such encounters are maintained by data keeper unit 64 in repository 68. Archiving unit 70 stores archived data in archive (data warehouse) database 72.

The collated claim data is submitted for pre-processing by trial adjudicator 48 using rules to validate the collated claim data is in condition for processing to initiate generation of payment. Trial adjudicator 48 initiates execution of a sub-set of rules executed by rule execution unit 46. Unit 46 detects the occurrence of an event triggering application of associated rules and executes the rules associated with that event. An event may include receipt of data to add to the repository 68, a request to execute a specified list of rules, an eligibility request, an eligibility response, a generated authorization, a claim creation, a claim submission, a remittance or request for additional information or an event triggered by the activities of a function within the FIG. 1 system. A rule executed by unit 46 may itself generate a triggering event and initiate execution of other rules. An individual rule may contain a test resulting in assignment of a result status of “True” or “False” upon execution of a rule. An individual rule may also contain lists of actions to be performed upon a true result and alternate actions to perform upon a false result, for example. The list of actions may include, creation of worklists of tasks for automatic or manual performance, creation of logs and audit reports and accounting reports, creation of error reports, generation of claims, posting of remittances, modification of data, and other actions. Data Morpher unit 44 comprises a sub-category of actions that rules invoke to modify data in repository 68 in response to command. Unit 46 also processes and executes rules stored in the Relationship Rules Repository 18 that contains rules required and used by the Protector 12, Translator 14, and Transporter 16 during communication involving interface 10.

The rules executed by trial adjudication unit 48 determine expected adjudication results when a specified set of claim data is submitted to a specified payer. Unit 48 uses rules derived from repository 74 (or from rule accessor 52) via rule keeper interface 66 to predict the result of submitting a specified set of claim data to a specified payer. For this purpose the rules used by unit 48 replicate the rules used by the selected specific payer. Unit 48 identifies conditions that would lead to denial of payment and enables such conditions to be fixed (automatically or with manual intervention) before a claim is submitted to a designated payer. This procedure advantageously facilitates the creation of error-free claims using rules derived from repository 74 or using remotely accessed rules. Rules including regulatory guidelines and directives are continuously acquired for storage in repository 74 and are continuously updated and maintained in this repository via rules keeper unit 66. System connectivity rules are also retained in repository 74 and also in relationship rules repository 18 (in support of communication via interface 10). Such connectivity rules support e-commerce communication (e.g., use FITP @ 2400 k baud to a certain node name) or determine a communication mode (e.g., prompt a user to e-mail to ask questions or probe a response. Other rules detect inconsistency between data fields such as data fields retaining a telephone number, zip code, address or other geographical identifier of the collated claim data.

Rules archiving unit 76 in conjunction with unit 66, dates and time stamps rules to be archived and stores obsolete, expired or older version rules in archive (rules warehouse) database 78. Repository 74 also contains rules developed by the system and by authorized participants that add automated processes to the system. Pattern creator unit 38 creates specialized rules that define surveillance research processes and rule maker unit 56 is used to create general purpose rules. Unit 48 uses rules in repository 74 derived from external rule sources (such as rules 62 owned by a payer institution 60) by rule accessor 52 via interface 10 and data network 58. Network 58 may comprise a conventional network such a LAN (local area network), WAN (wide area network) or the Internet or alternatively may comprise a network service such as a clearinghouse or other service used by a healthcare payer or a healthcare provider to facilitate data and rule (e.g., payer rules 62) acquisition for claim adjudication. Payer rules 62 are rules promulgated by a payer 60 that are not accessible through the automated process managed by Rule acquisition unit 54. Rather rules 62 are manually determined through manual acquisition processes and are parsed and analyzed by Rule acquisition unit 54 by using a user interface provided by rule maker unit 56. The Rule Maker 56 user interface supports manual creation, review and update of rules including those acquired via unit 54. Unit 56 also prompts a user with lists of available tests and actions and guides the user through the process of constructing and editing rules prior to storing the edited rules in Rules Repository 74.

Rule acquisition unit 54 accumulates rule data based on adjudication outcomes of prior claim submissions to payer institutions and through documentation and other information provided by payers that do not provide access to their proprietary programmed rule sets to external users. Unit 54 also receives new rules following user manual data entry and processing via a user interface provided by rule maker 56 based on information acquired from payers by rules gatherer service 80. Rule Checker unit 50 monitors rules in repository 74 and identifies and indicates to a user those rules that are incomplete or contain incorrect syntax. Unit 50 also reports combinations of rules that are mutually inconsistent. Further, in response to identification of a predetermined exception condition during claim data processing by rule execution unit 46 and trial adjudication unit 48, exception tracker function 42 employs a sub-set of rules managing the processing and reporting of an identified exception condition. Trial adjudicator 48 uses rule accessor 52 to submit claim data for trial adjudication by remotely located rules.

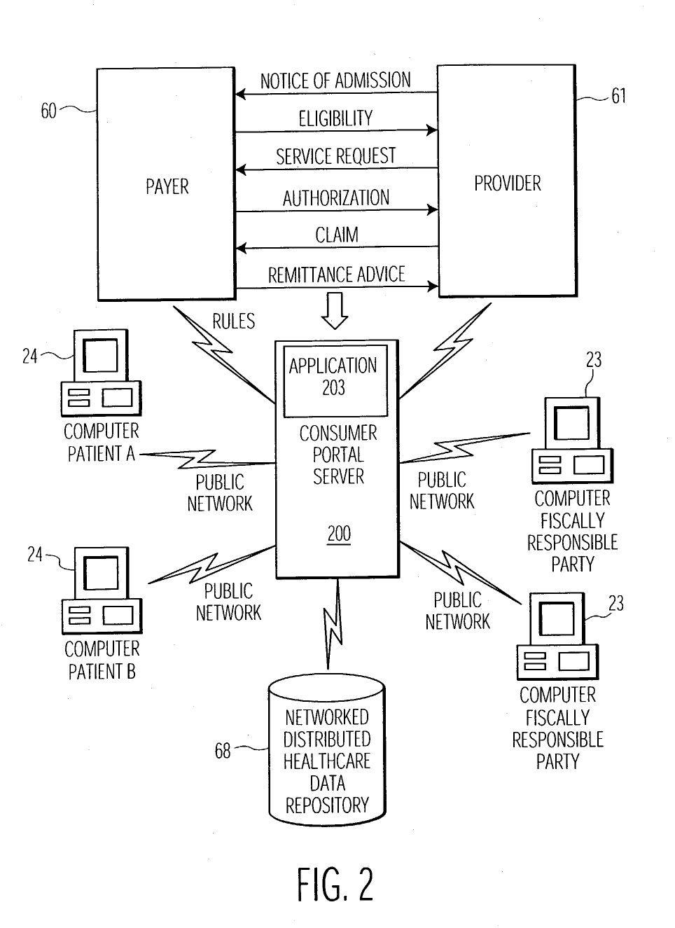

FIG. 2 shows a system arrangement enabling an authorized patient to access healthcare encounter related information and to actively monitor claim submission, billing and remittance processes via consumer portals 24. Accurate and timely access to healthcare encounter related information is enabled by use of aggregated healthcare encounter service, billing, and claim data in repository 68 in combination with constantly updated rules, regulatory guidelines and directives in repository 74 (FIG. 1). In operation, a patient, via a consumer portal 24, accesses application 203 executing on consumer portal server 200 providing a secured Internet compatible Web based user interface. Application 203 encompasses functions of FIG. 1 including those of rule execution unit 46. A patient employs the user interface provided by application 203 to access encounter related information in repository 68. Application 203 employs a security system including network firewalls and encryption and decryption algorithms to control access to the data. Application 203 also maintains a HIPAA (Health Insurance Portability & Accountability Act of Aug. 21 1996) compliant audit trail identifying any access to secure information. In response to an information request via portal 24, application 203 interprets the request and accesses the information using the logical record linkage capability of the structured relational database 68 to derive the desired encounter information. In another embodiment the logical linkage and mapping information may be resident in server 200 and be used by application 203 to access the information in repository 68. The database 68 logical linking structure links multiple encounters related to care including pre-admission testing, inpatient stay, outpatient follow-up, bills and payments across multiple providers and locations.

The linked information in repository 68 also associates encounter data and transaction data to enable a patient to monitor a progression of events including: admission, claim generation, remittance, and a request for additional information. In order to reduce information storage cost and potential storage redundancy, logical links to external databases such as to payer 60 and provider 61 databases are used. Repository 68 also accumulates non-redundant data from financial applications of multiple healthcare providers including those of hospital, clinic, and physician systems for presentation to a user via portal 24 (for this purpose the communication links are established as described in connection with FIG. 1). However, although the data may reside in multiple locations, it is logically connected and presented to the patient in a single view by application 203 operating in conjunction with repository 68. In another embodiment at the cost of additional storage, the required data is maintained in a central repository. Updates to repository 68 occur through a variety of input processes including ANSI (American National Standards Institute) X-12 compatible transactions mandated by HIPAA. For example, updates occur in response to X-12 compatible 270 (eligibility request), 271 (eligibility response), 278 (authorization), 837 (claim), and 835 (remit) transactions. Also online updates occur continuously in response to a transaction record being sent from one participant to another, for example. These updates ensure current information is available to the patient or responsible party.

A patient is advantageously able to use application 203 to determine the total cost of an episode of illness as well as to access claims and remittance records and other billing data for an episode of illness. Further, a patient or fiscally responsible party (via portal 23) is able to configure a view of data including composite or separate views of family member data and is also able to select a time frame for which encounter related activity is desired. A patient is further able to view a list of payers and providers participating in the consumer portal access system to facilitate choice of healthcare vendors or providers supporting easy access to information. A patient uses consumer portal 24 and application 203 to schedule a visit to a healthcare facility to receive a particular service. Application 203, in response, identifies whether the healthcare facility concerned collects insurance information from a patient and automatically initiates medical necessity, referral and eligibility verification processing. In addition, application 203 automatically pushes claim update information to a patient or responsible party via e-mail, if desired, to automatically notify the patient of any changes to a claim and related data.

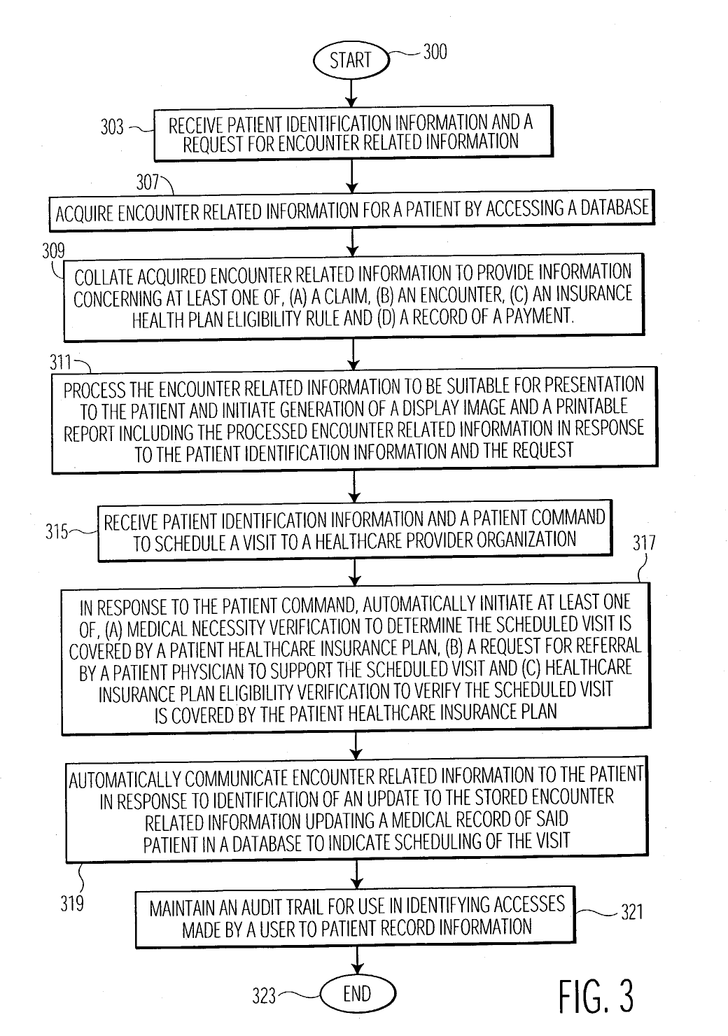

FIG. 3 shows a flowchart of a process employed in providing an authorized patient with access to healthcare encounter related information by the system of FIGS. 1 and 2. In step 303, after the start at step 300, application 203 (FIG. 2) receives patient identification information and a request for encounter related information. Encounter related information includes claim related data, transaction related data, patient hospital admission identification data, payment related data, data representing a request for information, data identifying a medical procedure authorization, clinical data associated with an encounter or data associated with reimbursement denial or acceptance, for example. In step 307, application 203 acquires encounter related information for a patient by accessing multiple databases including repository 68 (FIG. 2). Such multiple databases include hospital, clinic, physician or payer databases, for example. Repository 68 links a patient identifier with, records identifying patient encounters and data identifying at least one healthcare provider organization associated with the patient encounters and also with a record containing information related to the patient encounters. Repository 68 (or application 203 in another embodiment) maintains a map of available remote databases and associated communication data enabling bidirectional communication with available remote databases. Application 203 in step 309 collates the acquired encounter related information to provide supplemental healthcare information concerning a claim, an encounter, an insurance health plan eligibility rule, a record of a payment, a claim history, encounter related information over a user determined time period or encounter related information between user selected events. Application 203 also process the acquired information to provide collated encounter related information linking a patient identifier with, at least one record identifying multiple encounters, data identifying multiple healthcare provider organizations, data identifying multiple healthcare provider organization associated locations involved in delivering healthcare to a patient, at least one record containing encounter information related to multiple patient encounters, a total cost of multiple encounters associated with treatment of a patient medical condition and treatment eligibility information under a payer health plan applicable to a patient.

In step 311, application 203 processes the collated encounter related information to be suitable for presentation to a patient and initiates generation of a display image showing the processed information as a single encompassing record, a single display image, a scrollable display image, or a composite multi-window display image in response to the patient identification information and request. Application 203 further initiates generation of a printable report including the processed encounter related information in response to the patient request. In step 315, application 203 receives a patient command to schedule a visit to a healthcare provider organization. In response to the command, application 203 in step 317 automatically initiates medical necessity verification to determine whether the scheduled visit is covered by a patient healthcare insurance plan. Application 203 also automatically initiates a request for referral by a patient physician to support the scheduled visit and healthcare insurance plan eligibility verification to verify the scheduled visit is covered by the patient healthcare insurance plan. In addition, application 203 in step 319 updates repository 68 to record the scheduling of the visit and automatically communicates encounter related information to the patient in response to identification of an update to a medical record of the patient in repository 68 indicating scheduling of the visit. Application 203 maintains a HIPAA compliant audit trail for use in identifying accesses made by the patient to the medical record information in step 321. The process of FIG. 3 ends at step 323.

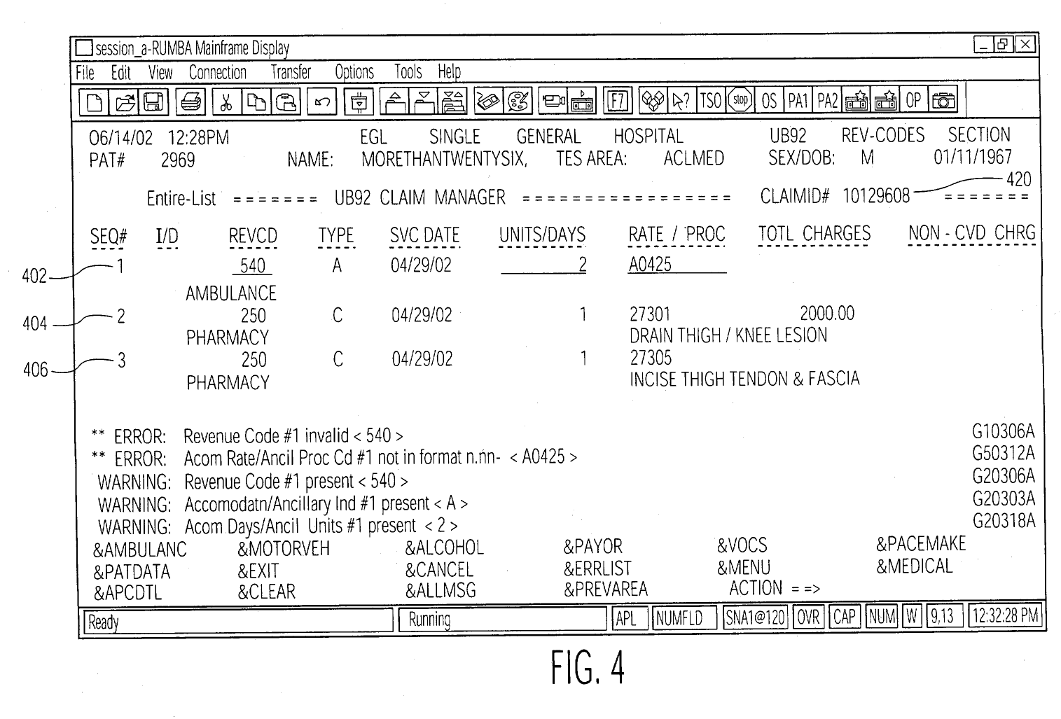

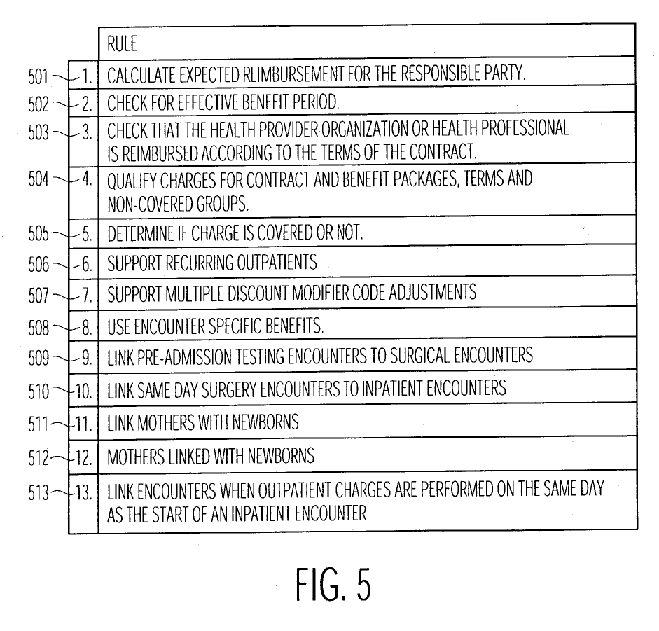

FIG. 4 shows a user interface display image illustrating a claim billing record accessible by a particular patient (the patient is identified by item 420) via portal 24. The billing record includes collated claim data for multiple patient encounters 402, 404 and 406 with a healthcare provider concerning treatment of an injury. Further, FIG. 5 shows exemplary claim data processing rules associated with clinical events occurring to a patient. A patient is able to monitor claim activity resulting from application of these rules via portal 24. Rules 501-513 in FIG. 5 are employed by unit 46 (FIG. 1) in application 203 of FIG. 2 to automatically validate and correct claim data for provision of services to a patient in response to triggering events. Claim data is processed by calculating expected reimbursement for services rendered to a patient one service at a time. In response to a record of a charge for a service being incorporated in a patient billing record, an expected reimbursement is computed for those active healthcare insurance policies that are applicable in order of their priority. Unit 46 executes rules 501-513 and other rules to validate compliance of claim data with payer requirements. Unit 46 does this for both individual service charges as they accumulate in a patient billing record and for an overall claim covering multiple services and associated charges.

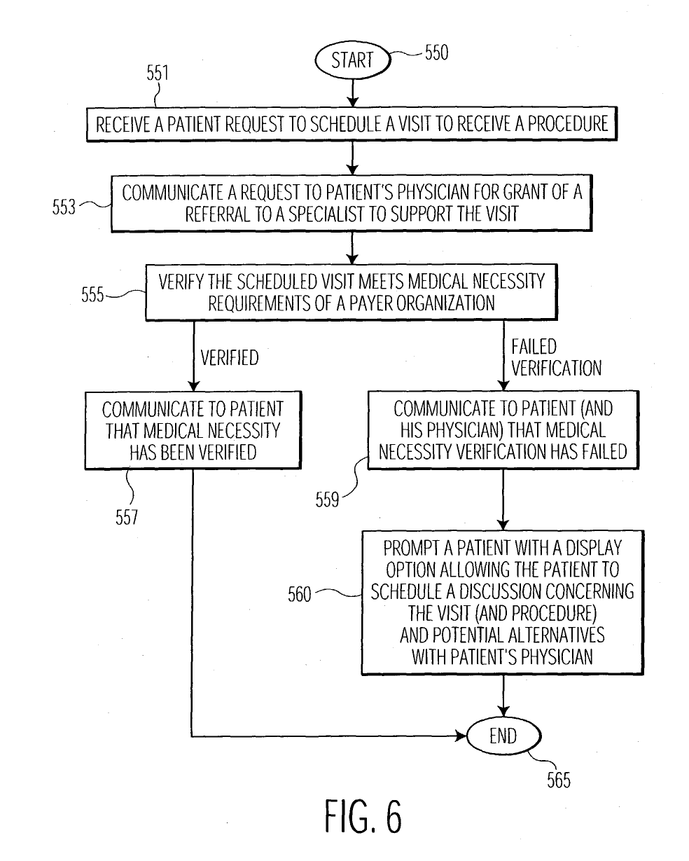

FIG. 6 shows a flowchart of a process supporting a patient in scheduling a visit to a healthcare provider to receive a proposed procedure and involving checking whether the proposed procedure meets medical necessity requirements of a payer. The process is executed by application 203 which encompasses the unit 46 and other processing functions of FIG. 1. A receipt of a patient request to schedule a visit to receive a procedure advantageously automatically triggers medical necessity determination by application 203. In FIG. 6, after the start at step 550 and receipt of a patient request to schedule a visit to receive a procedure in step 551, application 203 initiates communication of a request to a patient's physician to grant a referral to a specialist to support the visit in step 553. Application 203 also executes rules in step 555 in response to the patient request to schedule a visit to verify the scheduled procedure meets medical necessity requirements of a particular payer organization. Application 203 initiates communicating to the patient (and his physician) that either, medical necessity for the associated procedure has been verified in step 557 or that medical necessity verification failed in step 559. Upon a failure in step 559, application 203 in step 560 initiates generation of a prompt item to the patient allowing the patient to schedule a discussion with the patient's physician concerning the visit (and associated procedure) and potential alternatives. The process of FIG. 6 ends at step 565.

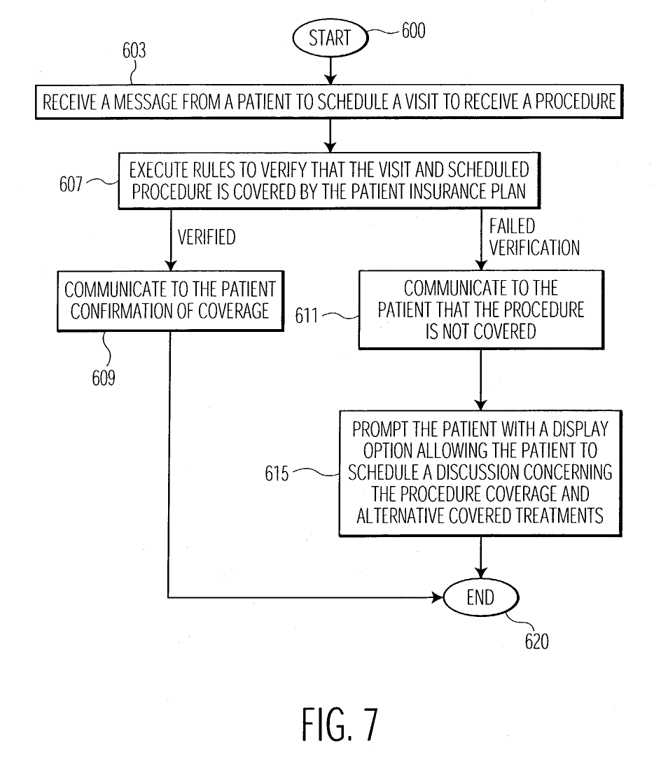

FIG. 7 shows a flowchart of a further process supporting a patient in scheduling a visit to a healthcare provider to receive a proposed procedure and involving determining whether a proposed procedure is covered by a patient healthcare plan. Specifically, application 203 advantageously automatically verifies that a patient is eligible for reimbursement for a visit or procedure under a patient medical insurance plan in response to a patient request to schedule a visit. In FIG. 7, after the start at step 600 and receipt of a patient request to schedule a visit to receive a procedure in step 603, application 203 executes rules in step 607 to verify that the scheduled visit or procedure is reimbursable under the patient medical insurance plan. Application 203 initiates communicating to the patient (and the patient's physician) that either, insurance coverage of the visit or procedure has been verified in step 609, or that the visit or procedure is not covered in step 611. If the patient is ineligible for reimbursement for the service based on contract terms, application 203 in step 615 initiates generation of a prompt item to the patient allowing the patient to schedule a discussion with the patient's physician concerning the procedure insurance coverage and potential alternative treatments that are reimbursable under the patient's health plan. Application 203 uses previously collected patient insurance information identifying a payer together with stored payer address information, to send eligibility requests to the identified payer. An individual healthcare provider determines rules concerning how long to wait for an eligibility response before initiating further actions (such as making a worklist entry, sending an e-mail, etc.) to expedite a response. Upon a non-coverage determination in step 611, a physician in step 615 may determine that a non-covered procedure is the preferred course of treatment. The process of FIG. 7 ends at step 620.

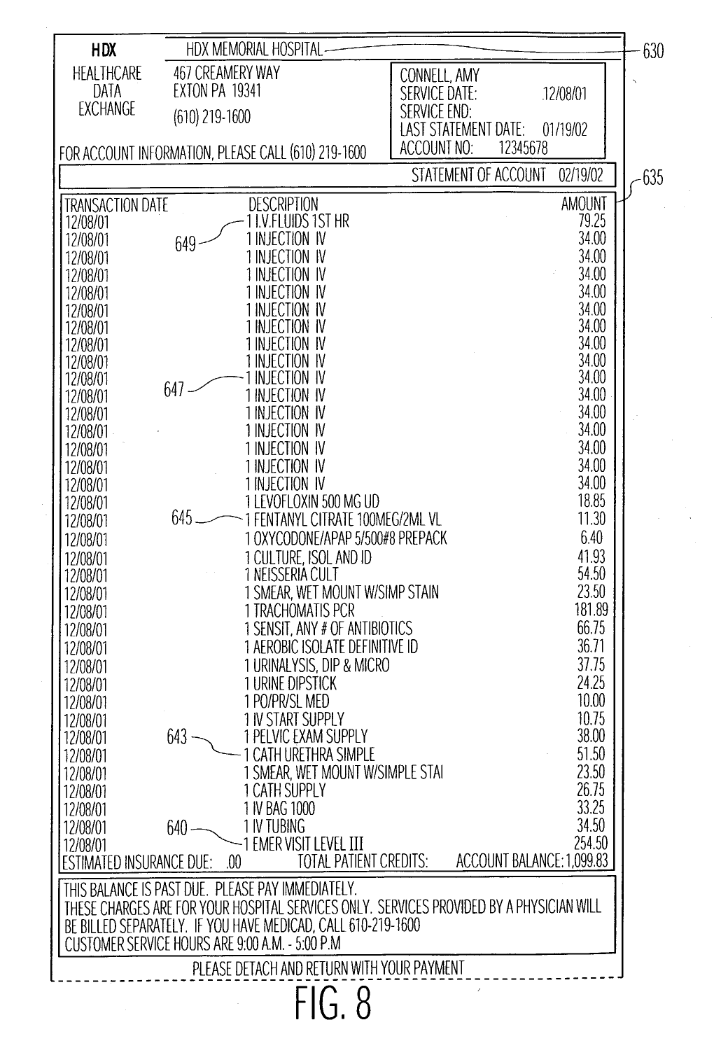

FIG. 8 shows collated encounter related information accessed by a patient via portal 24. A patient is able to configure a request for information to obtain information concerning the services and procedures and associated costs 635 for one or more episodes of illness. The example of FIG. 8 shows the procedures including procedures 640, 643, 645, 647, 649 administered in treating a patient for a medical condition by a single hospital (HDX Memorial item 630). However, a patient is also able to configure his request for information via pop-menus, for example, to obtain information for one or more episodes of care provided by multiple hospitals or other healthcare providers.

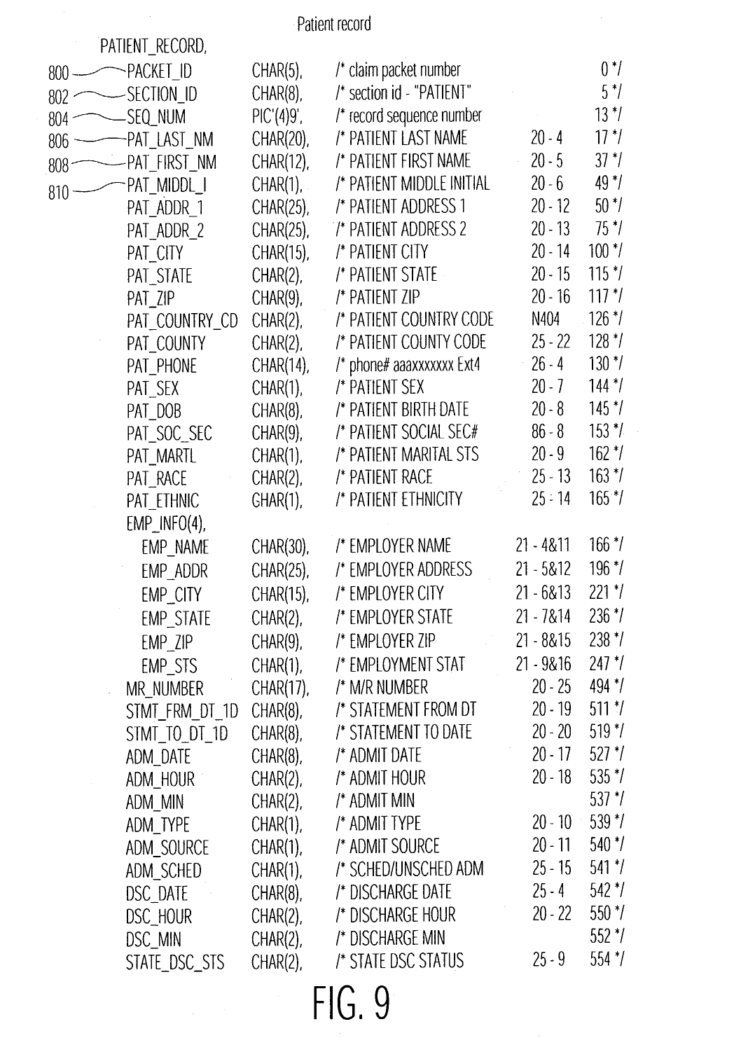

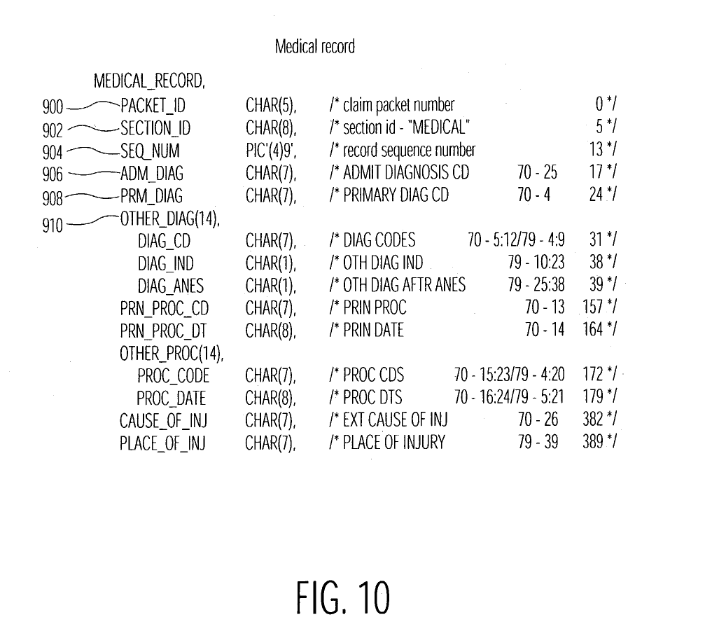

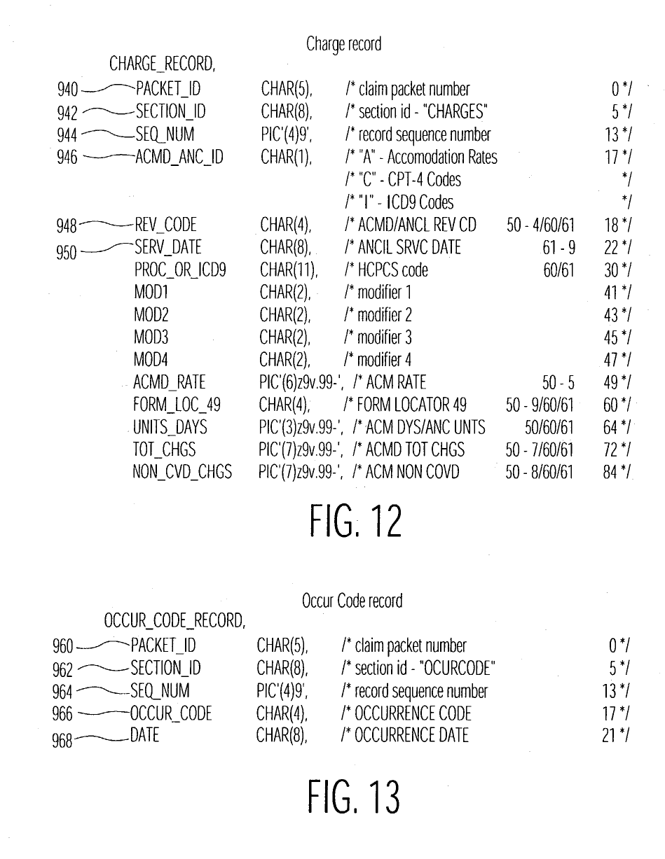

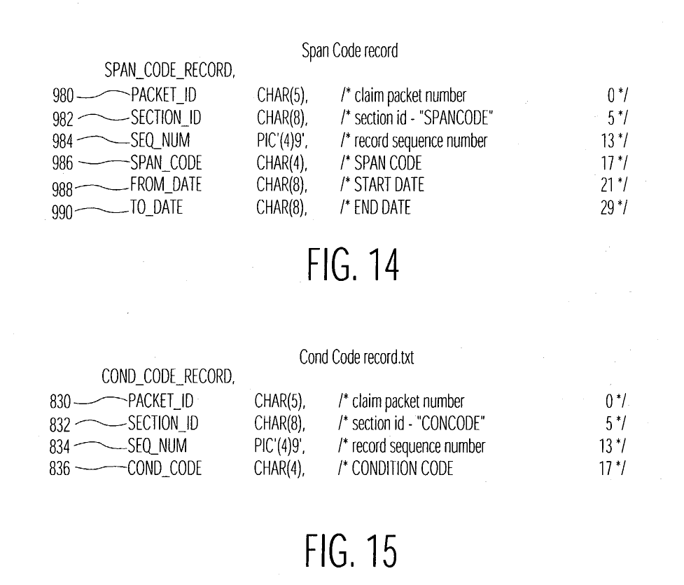

Aggregated healthcare encounter service, billing, and claim data that is provided to a patient via portal 24 is derived from data repository 68 and other remotely located databases as required. FIGS. 9-15 show healthcare encounter related information accessible by an authorized patient and incorporated in central data repository 68. Specifically, FIG. 9 shows a partial patient record data structure, FIG. 10 shows a medical record data structure and FIG. 1I shows a partial payer record data structure. A charge record data structure and occurrence code data structure are presented in FIGS. 12 and 13 respectively and FIGS. 14 and 15 indicate a span code and a medical condition code data structure respectively. A span code is another occurrence code for a clinical or other event that takes place over a period of time. These record structures are exemplary only and repository 68 typically contains other types of records associated with claim data such as, for example, records concerning ambulance services, rehabilitation services, treatments and other services and activities. The record structures of FIGS. 9-15 are individually accessible in repository 68 using a claim packet identifier (800, 900, 920, 940, 960, 980, 830), section identifier (802, 902, 922, 942, 962, 982, 832) and sequence number (804, 904, 924, 944, 964, 984, 834).

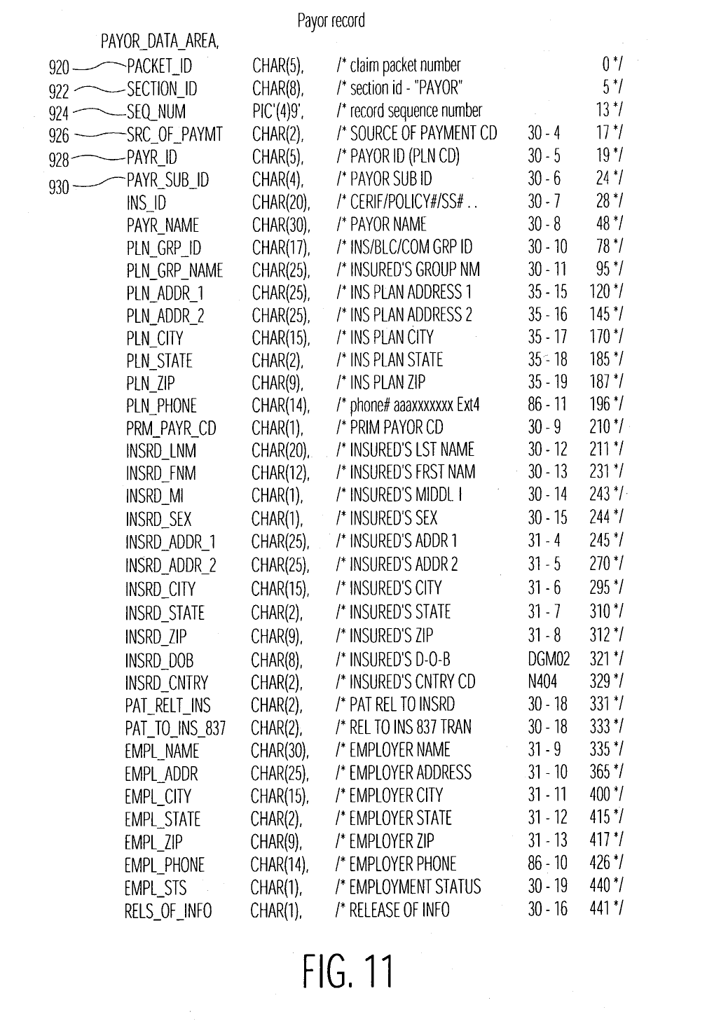

Data in an individual record data structure is field length delimited. In the patient record structure of FIG. 9, for example, a patient last name (806) occupies a fixed length of 20 characters, followed by a patient first name (808) occupying twelve characters and middle initial (810) occupying one character. The record structures of FIGS. 10-15 contain data related to other particular claim data aspects in similar predetermined fixed length fields. The medical record of FIG. 10, for example, contains an admission diagnosis code (906), as well as a primary diagnosis code (908) and other diagnosis codes (910). The payer record of FIG. 11 contains a source of payment code (926), as well as payer identifier (928) and payer sub-identifier (930). The charge record of FIG. 12 contains a service charge code (946), as well as a service charge revision code (948) and service date (950). The occurrence code record of FIG. 13 contains an occurrence identification code (966) and occurrence date (968). The span code record of FIG. 14 contains a span identification code (986), as well as a span determination start date (988) and end date (990) for use in identifying a period when the condition defined by the Span Code took place. For example, if a patient has had a similar illness, a span code 986 for that event is coded, and dates 988 and 990 are entered indicating the beginning and the end of the similar illness. In a second example, a span code 986 is used to define eligibility for a particular benefit, such as follow up treatment for 90 days and dates 988 and 990 identify a beginning and ending of the benefit period. The condition code record of FIG. 15 contains a medical condition identification code (836). The items referred to in connection with FIGS. 9-15 are described for exemplary purposes. However, other record items are shown in the record structures of FIGS. 9-12. These other items are representative of the breadth of data that may be included in the various records in the repository 68 structure, for example. In an alternative embodiment, other non-fixed length data record structure or another data record structure may be employed for repository 68.

Returning to FIG. 1, the healthcare encounter related data in repository 68 is collated by data acquisition unit 32 via interface 10 from multiple different sources as previously described and stored in repository 68 via data management system 64. A data emitter unit 34 provides healthcare encounter related data to an external entity (e.g., portals and participants 20-30) by extracting required claim data from repository 68 and communicating it via interface 10. Data reacher unit 36 is used by functions of the FIG. 1 system to provide read-only access to healthcare encounter related data stored by a remote entity and to make decisions based on this data. Further, healthcare encounter related data repository 68 is searchable by a patient and other users 30 via external portals 20-28 using data search criteria created using search pattern design function 38. Thereby a patient may initiate a search of repository 68 and collation of healthcare encounter related data for response to a patient request.

Search design function 38 employs a specialized category of rules stored in rules repository 74. An authorized user is able to use surveillance portal 28 via interface 10 to use the specialized category of search rules to support a search of rules and healthcare encounter related data information. Searchable information sources include rules repository 74, relationship rules repository 18 as well as healthcare encounter related data repository 68. For this purpose, search pattern evaluator function 40, employs a sub-set of rules executed by rule execution unit 46 to process a definition of a pattern search created by pattern design function 38. Specifically, pattern evaluator function 40 identifies patterns in the data searched according to action steps included in the search definition and reports results to the search initiator via interface 10. A pattern search may also be initiated in response to occurrence of an event. An event may include, for example, a command (in response to a request by a participant), or upon detection of a change in particular data (receipt of a specific diagnosis, for example) or an internally generated event such as in response to expiration of a particular time period.

Interface 10 provides access by various interested participants 30 in the claim data processing operation via portals 20-28 for searching, viewing or initiating actions. Thereby a participant (such as a healthcare provider, payer institution representative, patient, employer or government agency) is able to access healthcare encounter related data, payer rules and initiate various actions such as a data correction action, for example. Specifically healthcare providers and healthcare payer representatives are able to access the system via portals 20 and 22 that provide the functions these entities respectively require. A healthcare provider, for example, is able to input financial data and associated clinical data into repository 68 and to initiate and manage claim trial adjudication and other rule-driven processes via portal 20. Similarly, a provider is able to automatically modify its own data based on automated rules or through manual amendment and update. A provider is further able to initiate submission of validated error-free claims for payment and to initiate claim status inquiries. In addition, a provider via portal 20 is able to acquire remittance advice (i.e., information about payments made) and to automatically post acquired advice to corresponding correct accounts as well as to generate and submit secondary and tertiary claims and obtain worklists (of tasks to be performed) and reports in support of management of its business.

A payer institution is able to use portal 22 to store and maintain adjudication rules in repository 74 and to receive claim data for trial or actual (determinative) adjudication as well as to respond to claim status inquiries. A payer is further able to communicate a request for information or remittance advice and obtain worklists and reports and manage its business and revenue cycle. A patient, covered dependent or healthcare plan subscriber with appropriate authorization is able to use consumer portal 24 to view his own claim data records and claim status and research rules governing payment as previously described. A patient is also able to correct errors in his own demographic data or medical record and to schedule appointments via the system. A patient is also able to obtain account balance, recent transaction records, future deposit information and request payment from a medical expense reimbursement account for items paid out of pocket.

An employer, or another plan administrator, is able to use portal 26 to manage healthcare encounter cycle business and to negotiate healthcare contracts on behalf of a group of persons (employees) and to monitor activity related to those employees. For this purpose, an employer is able to obtain, for example, a worklist or a report identifying incidence of various diagnoses, utilization of various providers, a breakdown of charges (e.g. those paid by members, contractually reduced, or denied). Thereby an employer is able to determine if plan members would benefit from an alternative health plan selection. Surveillance portal 28 enables authorized participants 30 (e.g. a regulator or researcher) to create and implement research projects to analyze stored claim data by searching for patterns or trends in the claim data of repository 68 in conjunction with rules repository 74. Specifically, surveillance portal 28 in conjunction with search pattern design and implementation units 38 and 40 respectively, supports searches to, (1) generate periodic statistical reports, (2) detect claim fraud and abuse, and (3) detect outbreaks of epidemics, caused either by natural disease or by human (terrorist) activity and other searches, for example. Search results may include worklists or reports and search criteria may be stored as rules in rules repository 74.

Interface 10 provides access by participants 30 to claim data and rule repositories 68 and 74 via portals 20-28 using a security function 12, translator function 14 and transport function 16. Security function 12 determines whether a participant is authorized to communicate with another particular participant and whether a participant is authorized to access particular data and assigns participant privileges and entitlements and maintains security and access rules. Unit 12 rejects and tracks unauthorized requests that violate security and other (e.g., HIPAA) policies. Translator function 14 converts data between the different data formats used by internal and external participants in the FIG. 1 system. For this purpose, translator 14 converts data from a first data format into an internally defined intermediate data format and from the intermediate format into a desired output data format. Transport function 16 supports communication of data and messages between internal functions of the FIG. 1 system and between internal functions and external participants. For this purpose function 16 uses relationship rules repository 18 to identify required connection protocols and methods as well as source and destination addresses. Function 16 also uses rules repository 18 in encoding data in the appropriate message format and protocol and in initiating necessary hand shaking and other routines required to implement bidirectional communication.

Relationship rules repository 18 contains information identifying the application programmer interfaces (APIs) used by participant and system software applications and the required procedure for requesting information from particular sources and providing information to particular participants. The participant API identification and related communication information is provided by individual participants for storage in repository 18. The participants retain control over and maintain their respective communication support information. Interface 10 uses the stored predetermined API and communication information in supporting conversion of data from a first data format into an internally defined intermediate data format and from the intermediate format into a desired output data format. As a consequence, participants are able to update their own systems and to communicate with other participants regardless of the rule standards in use or whether the repositories are migrated to new platforms or radically altered in other ways. Also data format standards involved may be changed by an individual participant without impeding operation by other participants. For this purpose interface 10 uses relationship repository 18 to process the validated claim data to provide the data format, protocol, handshaking routine and submission procedure predetermined (and retained and identified in repository 18) by the payer.

The systems, processes and user interface display formats presented in FIGS. 1-15 are not exclusive. Other systems, processes and user interface forms may be derived in accordance with the principles of the invention to accomplish the same objectives. The inventive principles are applicable to providing secure consumer access to information of interest in other industries and are particularly applicable to the insurance, government and healthcare industries.

What is claimed is:

1. A system supporting patient access to healthcare encounter related information including information concerning an event involving interaction of a patient with a healthcare enterprise, comprising:
an interface processor for receiving patient identification information and a request for encounter related information;
a database linking a patient identifier with,
a record identifying at least one patient encounter and
data identifying at least one healthcare provider organization associated with said at least one patient encounter and
a record containing encounter information related to said at least one patient encounter; and
a data processor for accessing said database to provide encounter related information for a patient and processing said encounter related information to be suitable for output communication for presentation to said patient in response to said patient identification information and said request.

2. A system according to claim 1, wherein
said interface processor receives a patient command to schedule a visit to a healthcare provider organization, and
in response to said command, said data processor automatically initiates at least one of, (a) medical necessity verification to determine said scheduled visit is covered by a patient healthcare insurance plan, (b) a request for referral by a patient physician to support said scheduled visit and (c) healthcare insurance plan eligibility verification to verify said scheduled visit is covered by said patient healthcare insurance plan.

3. A system according to claim 2, wherein
said data processor updates said database to record the scheduling of said scheduled visit.

4. A system according to claim 1, wherein
said system includes a communication processor for communicating with a remote database for acquiring requested encounter related information for said patient in response to said patient identification information and said request.

5. A system according to claim 4, wherein
said system includes a map of available remote databases and associated communication data enabling said communication processor to establish bi-directional communication with an available remote database(s).

6. A system according to claim 1, wherein
said encounter comprises an event involving interaction of a patient with a healthcare enterprise and includes at least one of, (a) a visit, (b) a phone call, (c) an interview, (d) an examination, (e) a procedure, (f) a treatment related occurrence, (g) an admission to a healthcare enterprise, (h) a test and (i) an order for medication.

7. A system according to claim 1, wherein
said system includes a communication processor for automatically communicating encounter related information to said patient in response to identification of an update to said encounter related information.

8. A system according to claim 1, wherein
said encounter related information comprises at least one of, (a) claim related data, (b) transaction related data, (c) patient hospital admission identification data, (d) payment related data, (e) data representing a request for information, (f) data identifying a medical procedure authorization, (g) clinical data associated with the encounter and (h) data associated with reimbursement denial or acceptance.

9. A system according to claim 1, wherein
said system supports guarantor access to healthcare encounter related information and
said data processor accesses said database to provide encounter related information for a patient and processing said encounter related information to be suitable for output communication for presentation to said guarantor in response to guarantor identification information and a request for encounter related information from said guarantor.

10. A system according to claim 9, wherein
said guarantor comprises a payer organization responsible for reimbursing a healthcare provider for at least a portion of medical costs for a patient visit.

11. A system according to claim 1, wherein
said data processor encrypts said encounter related information for secure output communication for presentation to said patient.

12. A system supporting patient access to healthcare encounter related information including information concerning an event involving interaction of a patient with a healthcare enterprise, comprising:
an interface processor for receiving patient identification information and a patient command to schedule a visit to a healthcare provider organization;
a database including a medical record for said patient; and
a data processor for,
automatically initiating at least one of, (a) medical necessity verification to determine said scheduled visit is covered by a patient healthcare insurance plan, (b) a request for referral by a patient physician to support said scheduled visit and (c) healthcare insurance plan eligibility verification to verify said scheduled visit is covered by said patient healthcare insurance plan, and for
updating said medical record in said database to indicate scheduling of said visit.

13. A system supporting patient access to healthcare encounter related information including information concerning an event involving interaction of a patient with a healthcare enterprise, comprising:
an interface processor for receiving patient identification information and a request for encounter related information;
a communication processor for communicating with a plurality of databases for acquiring requested encounter related information for said patient in response to said patient identification information and said request; and
a data processor for collating encounter related information for a patient acquired from said plurality of databases using said communication processor, said collated encounter related information linking a patient identifier with,
a record identifying at least one patient encounter and
data identifying at least one healthcare provider organization associated with said at least one patient encounter and
a record containing encounter information related to said at least one patient encounter.

14. A system according to claim 13, wherein
said data processor maintains an audit trail for use in identifying accesses made by a user to patient record information.

15. A system according to claim 13, wherein
said collated encounter related information links a patient identifier with at least one of, (a) at least one record identifying multiple encounters, (b) data identifying multiple healthcare provider organizations, (c) data identifying multiple healthcare provider organization associated locations involved in delivering healthcare to said patient, (d) at least one record containing encounter information related to multiple patient encounters, (e) a total cost of multiple encounters associated with treatment of a patient medical condition and (f) treatment eligibility information under a payer health plan applicable to said patient.

16. A system according to claim 13, wherein
said data processor processes said collated encounter related information to be suitable for presentation to said patient in at least one of, (a) single encompassing record, (b) a single display image, (c) a scrollable display image, (d) a printable report and (e) a composite multi-window display image.

17. A system according to claim 13, wherein
said plurality of databases comprise databases containing encounter related information for at least one of, (a) a hospital, (b) a clinic, (c) a physician, (d) a payer, (e) pharmacy, (f) Long-Term-Care facility, (g) Skilled Nursing facility, (h) Ambulance and (i) Durable Medical Equipment

18. A system according to claim 13, wherein
said plurality of databases include a payer database and
said communication processor is able to communicate with said payer database to acquire encounter related information comprising treatment eligibility information under a payer health plan applicable to said patient.

19. A system according to claim 13, including
an authorization processor for authorizing access to records of said patient by an entity in response to received authorization information from said patient authorizing said entity to access records of said patient.

20. A system according to claim 13, including
an authorization processor for authorizing access to records of an individual related to said patient in response to received healthcare insurance policy information provided by said patient.

21. A system according to claim 20, wherein
said authorization processor authorizes access to records of an individual related to said patient by an employee of a payer organization.

22. A system supporting patient access to healthcare encounter related information comprising information concerning an event involving interaction of a patient with a healthcare enterprise, comprising:
an interface processor for receiving patient identification information and a request for encounter related information;
a data processor for
acquiring requested encounter related information for said patient and for
supporting user communication with a payer organization and a healthcare provider concerning said acquired encounter related information in response to said received patient identification information and said request.

23. A system according to claim 22, wherein
said data processor acquires encounter related information to provide collated encounter related information linking a patient identifier with,
a record identifying at least one patient encounter and
data identifying at least one healthcare provider organization associated with said at least one patient encounter and
a record containing encounter information related to said at least one patient encounter.

24. A system according to claim 22, wherein
said data processor supports user communication with a payer organization and a healthcare provider for at least one of, (a) correcting said acquired encounter related information and (b) supplementing said acquired encounter related information.

25. A user interface system supporting patient access to healthcare encounter related information including information concerning an event involving interaction of a patient with a healthcare enterprise, comprising the steps of:
receiving patient identification information and a request for encounter related information;
accessing a database to provide encounter related information for a patient, said database linking a patient identifier with,
a record identifying at least one patient encounter and
data identifying at least one healthcare provider organization associated with said at least one patient encounter and
a record containing encounter information related to said at least one patient encounter; and
processing said encounter related information to be suitable for presentation to said patient in response to said patient identification information and said request.

26. A system according to claim 25, including the step of
initiating generation of a display image and a printable report including said processed encounter related information in response to said request.

27. A system according to claim 25, including the step of
collating said acquired encounter related information to provide at least one of, (a) a claim history, (b) encounter related information over a user determined time period and (c) encounter related information between user selected events.

28. A system according to claim 25, including the step of
collating said acquired encounter related information to provide supplemental healthcare information concerning at least one of, (a) a claim, (b) an encounter, (c) an insurance health plan eligibility rule and (d) a record of a payment.

29. A system according to claim 25, including the steps of
acquiring and collating encounter related information for a plurality of individuals and
processing said collated encounter related information for said plurality of individuals to be suitable for presentation to a user.

30. A method enabling patient access to healthcare encounter related information comprising information concerning an event involving interaction of a patient with a healthcare enterprise, comprising the steps of:
receiving patient identification information and a patient command to schedule a visit to a healthcare provider organization;
in response to said patient command,
automatically initiating at least one of, (a) medical necessity verification to determine said scheduled visit is covered by a patient healthcare insurance plan, (b) a request for referral by a patient physician to support said scheduled visit and (c) healthcare insurance plan eligibility verification to verify said scheduled visit is covered by said patient healthcare insurance plan; and
updating a medical record of said patient in a database to indicate scheduling of said visit.
